(19) United States
(12) Patent Application Publication
(10) Pub. No.: US 2004/0173217 A1
(43) Pub. Date: Sep. 9, 2004

(54) Folding knee and/or ankle pad positioner

(76) Inventor: Haskell L. Sells II, Raleigh, NC (US)

Correspondence Address: Haskell Lee Sells II, 3900 Yew Circle, Raleigh, NC, 27612, US

(21) Appl. No.: 10/377,360

(22) Filed: Mar. 3, 2003

(51) Int. Cl. A61G 15/00

(52) U.S. Cl. 128/845

(57) ABSTRACT

In the healthcare field there are specific wounds generally referred to as “pressure ulcers” or “decubitus ulcers”. These wounds are generally caused by: direct constant pressure to body tissues; internal disease or disorders which surface on the skin; urine or fecal material constantly in contact with skin causing breakdown; lack of proper nutrition; or, a combination of all of these factors. These wounds occur mostly on “bed-ridden patients” whose debilitation is such that they cannot react to their body's neurological signals for them to adjust their position. Most of these patients are prone, some are underweight with out muscle or fatty tissue (which leads to more severe “bony prominences”), some are contracted, and most lay on standard mattresses.

These “pressure ulcers” can occur in any area of the body but are predominately found in the shoulders, coccyx, hip, legs, and heels. Actually, any “bony-prominence” is a candidate for breakdown if pressure is allowed to be against it constantly.

There have been many attempts to “cure” or “treat” these “pressure ulcers”. There are nursing attempts to turn the patient every two hours to prevent the wounds from occurring. There have been products produced to give “floatation” to these patients to help relieve pressure. These products range from low air loss floatation beds to static air mattresses to foam (trapped air) overlays to body positioners.

### FIELD OF THE INVENTION

In the past, knee and/or ankle positioners have consisted of such items as pillows, polystyrene filled bags, foam abduction pillows with straps, foam foot cradles with straps, and orthopedic “wraps”. The problem with these “manufactured products ” include: appropriate use for knees and/or ankles, i.e., abduction pillows are large “V” shaped products intended for post-operative care of hip surgery patients and are not appropriate for contracted, “bed-ridden” patients; foam cradles are generally for one foot only, are generally uncomfortable and, depending on the style, may not be appropriate for ankles and does not address problems with knees; orthopedic “wraps” are a “quilt-like” material in construction and wraps around (encapsulates) one knee and attaches with straps which can be too tight (causing breakdown) or too loose (non-functional). Pillows have their own set of problems in that they are not clearly defined as a knee and/or ankle positioning product; they do not stay in position; due to their initial bulk, it is often uncomfortable for the patient when pillows are placed between the knees; they “deflate” to a point of almost no support for positioning; they are not of a consistent density or performance.

An appropriate positioner should be cool, comfortable, and well accepted by the patient. It should provide the healthcare personnel a positioner which is easy to place between the knees, the ankles, or both the knees and the ankles to help prevent skin breakdown; it should provide immediate visual assessment of the patient's knee and/or ankle position and skin condition. It should be uniform in its' size so that there is no guessing on the healthcare personnel as to sizing, it should be a “one size fits all”. It should be non-encapsulating to help prevent heat build up or pressure from straps. It should be a low profile positioner for easy and comfortable placement between the knees and/or ankles without discomfort to the patient; it should be of a consistent material for continuity of care over time.

### OBJECT

It is, therefore, an object of the present invention to provide a new and novel knee and/or ankle positioner for helping to protect patient's knees and/or ankles from breakdown.

Another object of the present invention is to make this positioner easily identifiable by healthcare staff as to its' purpose; to provide immediate visual assessment of the knee and/or ankle position and skin condition; to be uniform in its' size so that “one size fits all”; to be a low profile so as to be easily placed and comfortable for the patient; to allow the knees and/or ankles to be free, unencumbered by straps or encapsulating material.

### SUMMARY OF THE INVENTION

A knee and/or ankle positioner designed to assist in the appropriate positioning of a patient whose knees and/or ankles have been identified as having the potential for skin breakdown, is placed between the knees and/or ankles. The positioner positions the patient in such a manner as to help knees and/or ankles from maintaining pressure knee to knee, ankle to ankle, or both knee to knee and ankle to ankle. The positioner is passive in that it is strategically placed by a nurse (or other healthcare professional) so as to best benefit the patient. It will provide immediate visual assessment of the knees and/or ankles; it will be cool (that is, there will be no heat build up due to an encapsulating effect; it will be free of straps; it will be easily recognizable by the healthcare staff as intended for knees and/or ankles.

### DETAILED DESCRIPTION OF PRODUCT AND DRAWING

Brief description of the drawings

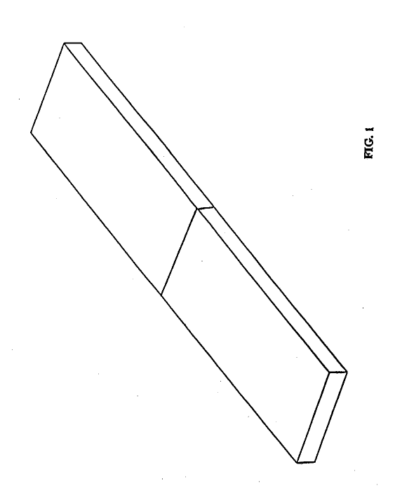

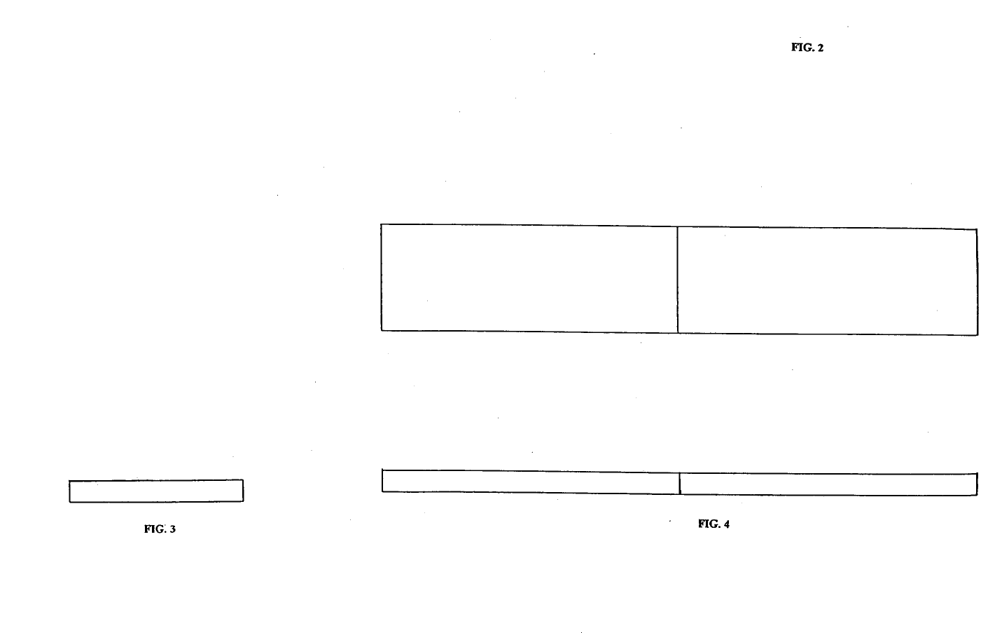

FIG. 1 is an isometric view of the positioner.

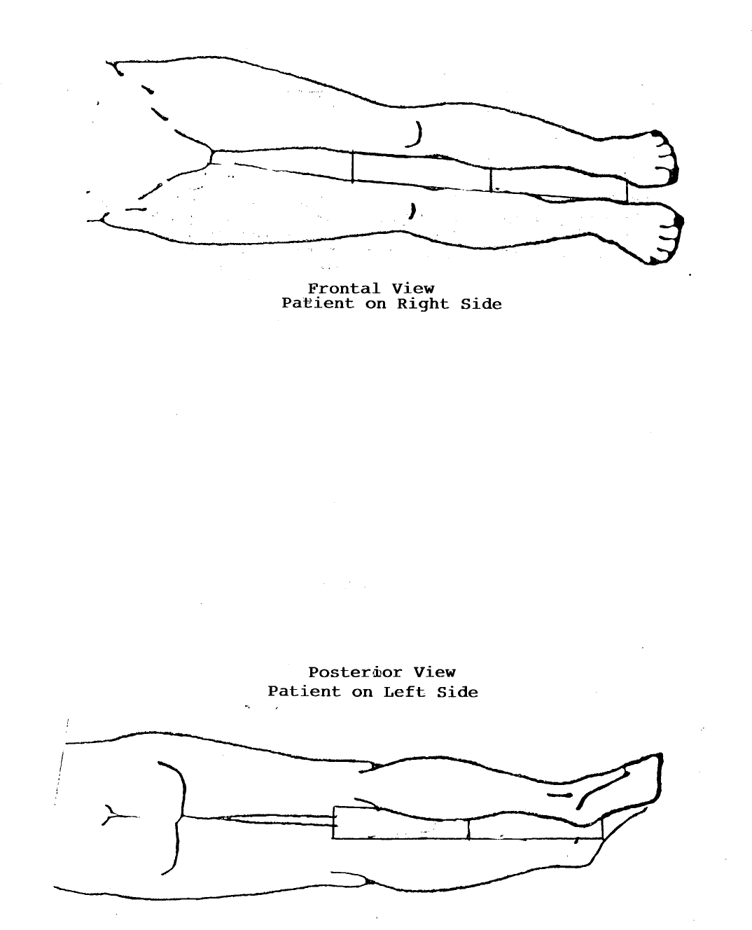

FIG. 2 is a top plan view of the positioner.

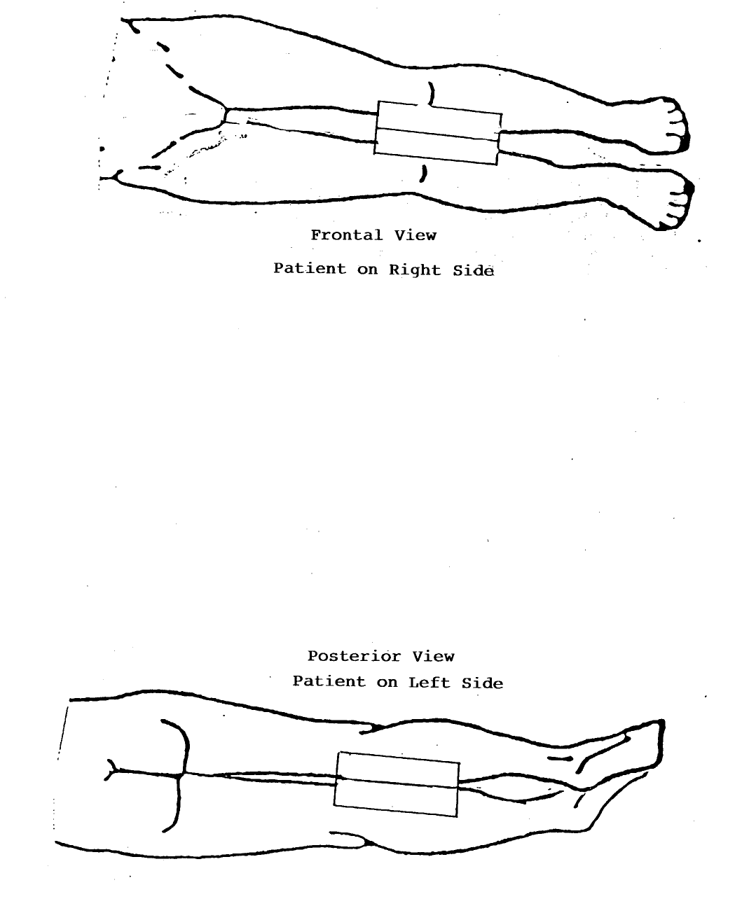

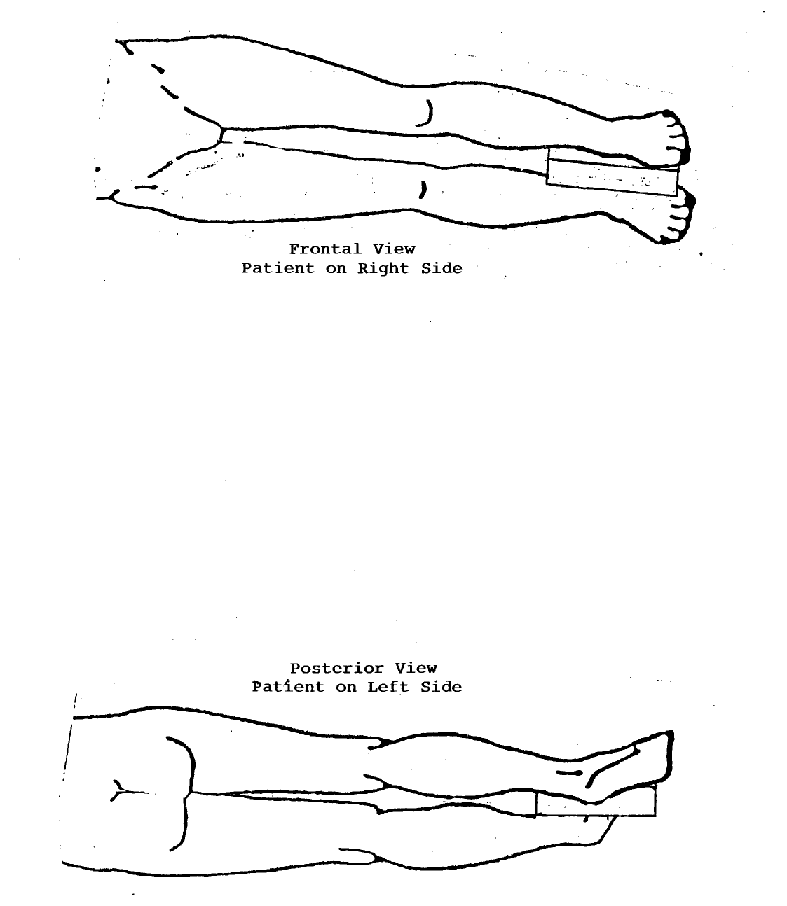

FIG. 3 is a side elevation of FIG. 1.

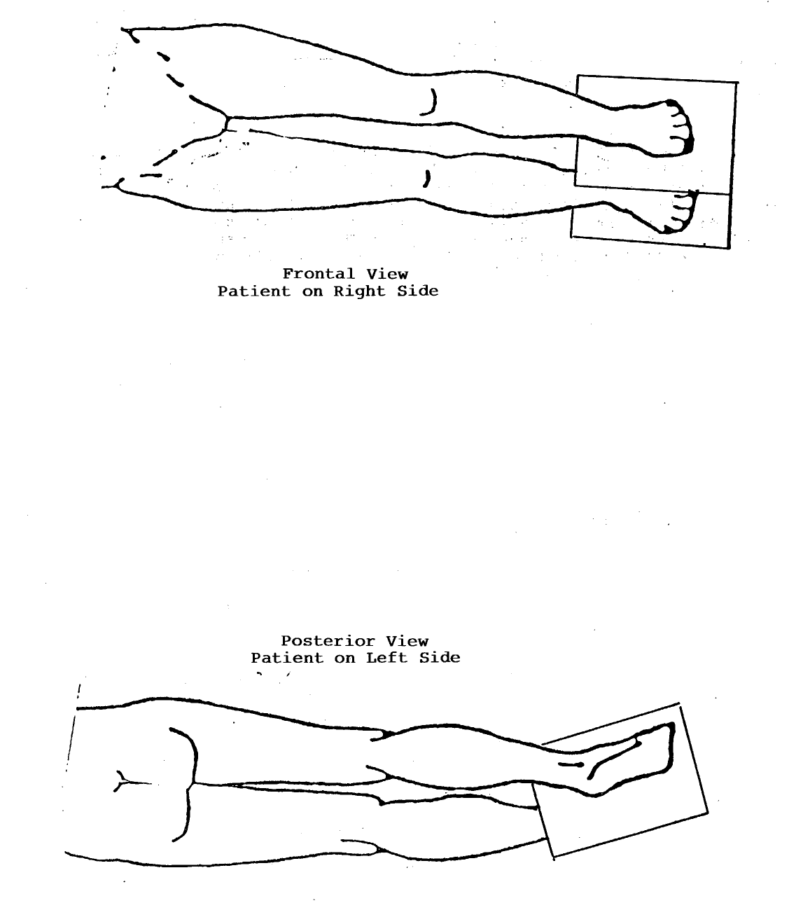

FIG. 4 is a rear elevation.

### DETAILED DESCRIPTION OF PRODUCT AND DRAWINGS

The invention is the design of the positions 10, in that the positioner is the first “low profile knee and/or ankle” positioner; the first to be designed for use solely with both knees and ankles, or solely with knees, or solely with ankles. While the design could be made from a variety of materials, the present design is composed of foam which is of a 1.45 density and an indentation load deflection of 36 (See FIGS. 1 and 3). The foam is initially cut 34 inches wide, with that width cut into two equal parts of 17 inches each (while the current invention is of this size and cut, any width or un-equal parts of material could be used), joined by a material (in this presentation, the material is rip-stop nylon, but could be any material and the joining could be by any material or other mechanical means) sewn in such a manner in which the two parts can be laid out flat (straight) or folded over, one part on top of the other in which case the “folded width” is 17 inches; the length is 11 inches; the height is 11/2 inches when flat and 3 inches in height when “folded”.

What is claimed is:

1. A therapeutic positioning device for preventing or assisting in the healing of ulcers and other skin breakdown of the knees and/or ankles comprised of a resilient body, said body being constructed of a single rectangular layer of foam, said rectangle layer is thirty four inches in width (comprised of two equal seventeen inch resilient bodies joined in a manner allowing them to fold one on top of the other) and eleven inches in length and one and one half inches in height.

2. A therapeutic positioning device for preventing or assisting in the healing of ulcers and other skin breakdown of the knee (or knees) comprised of a resilient body, said body being constructed of a single rectangular layer of foam, said rectangular layer is thirty four inches in width (comprised of two equal seventeen inch resilient bodies joined in a manner allowing them to fold one on top of the other) and eleven inches in length and one and one half inches in height.

3. A therapeutic positioning device for preventing or assisting in the healing of ulcers and other skin breakdown of the ankle (or ankles) comprised of a resilient body, said body being constructed of a single rectangular layer of foam, said rectangular layer is thirty four inches in width (comprised of two seventeen inch resilient bodies joined in a manner allowing them to fold one on top of the other) and eleven inches in length and one and one half inches in height.

4. A therapeutic positioning device for preventing or assisting in the healing of ulcers and other skin breakdown of the ankle (or ankles) comprised of a resilient body, said body being constructed of a single rectangular layer of foam, said rectangular layer is thirty four inches in width (comprised of two seventeen inch bodies joined in a manner allowing them to fold, to be flat or to be partilly open) and eleven inches in length and one and one half inches in height.
